(19) United States
(12) Patent Application Publication
(10) Pub. No.: US 2024/0300465 A1
(43) Pub. Date: Sep. 12, 2024

(54) REDUNDANCY VALVE ASSEMBLY AND BRAKE SYSTEM HAVING PRESSURE MODULATION VIA REDUNDANTLY FORMED ABS VALVES

(71) Applicant: ZF CV Systems Global GmbH, Bern (CH)

(72) Inventor: Julian van Thiel, Grossburgwedel (DE)

(21) Appl. No.: 18/665,964

(22) Filed: May 16, 2024

Related U.S. Application Data
(63) Continuation of application No. PCT/EP2022/080474, filed on Nov. 2, 2022.

(30) Foreign Application Priority Data
Nov. 30, 2021 (DE) 10 2021 131 328.7

(51) Int. Cl. B60T 13/68; B60T 8/36; B60T 8/88; B60T 8/94; B60T 13/36

(52) U.S. Cl. CPC B60T 13/683; B60T 8/3605; B60T 8/885; B60T 8/94; B60T 13/36; B60T 2240/00; B60T 2270/10; B60T 2270/402; B60T 2270/413

(57) ABSTRACT

A redundancy valve assembly is for redundantly supplying a redundant brake pressure into a service brake pressure path of an electronically controllable pneumatic brake system for a vehicle, preferably a utility vehicle, including a service brake pressure connection for receiving a service brake pressure from a service brake pressure modulator, a redundancy brake pressure connection for receiving a redundancy brake pressure from a redundancy brake pressure modulator, and a brake actuator connection for connecting at least one brake actuator. The redundancy valve assembly is electrically actuatable in order to optionally modulate the service brake pressure or the redundancy brake pressure at the brake actuator connection. An electronically controllable pneumatic brake system includes a redundancy control unit. A vehicle includes the electronically controllable pneumatic brake system. A method is for controlling an electronically controllable pneumatic brake system.

### CROSS-REFERENCE TO RELATED APPLICATIONS

This application is a continuation application of international patent application PCT/EP2022/080474, filed Nov. 2, 2022, designating the United States and claiming priority from German application 10 2021 131 328.7, filed Nov. 30, 2021, and the entire content of both applications is incorporated herein by reference.

### TECHNICAL FIELD

The disclosure relates to a redundancy valve assembly for redundantly supplying a redundant brake pressure into a service brake pressure path of an electronically controllable pneumatic brake system for a vehicle, preferably a utility vehicle, including a service control unit for controlling the electronically controllable pneumatic brake system in an operating mode, at least one service axle modulator which is connected to the service control unit and receives service braking signals from the latter and, based thereon, modulates a service brake pressure for a first axle, and a redundancy control unit for controlling the electronically controllable pneumatic brake system in a redundancy mode. Furthermore, the disclosure also relates to a vehicle, preferably a utility vehicle, including at least a first axle and a second axle and an electronically controllable pneumatic brake system. In addition, the disclosure relates to a method for controlling an electronically controllable pneumatic brake system.

### BACKGROUND

Concepts for the redundant modulation of a brake pressure are intended to enable redundant braking of the vehicle, particularly in the event of a fault in a brake system that partially or completely prevents the modulation of a service brake pressure. Known concepts for redundant modulation of a brake pressure generally use partially redundant components and partially existing components to modulate the brake pressure. For example, US 2019/0152459 discloses a system in which, in the event that a central control unit fails, which would otherwise electronically actuate a front axle modulator, a bypass valve pneumatically controls a redundancy pressure, which is then provided to the front axle modulator in order to achieve redundant pneumatic modulation of the front axle brake pressure. In general, US 2019/0152459 discloses an electronically controllable pneumatic brake system with at least two brake circuits, wherein an electrically and pneumatically controllable control valve is assigned to at least one of the at least two brake circuits and an electrically controllable parking brake valve is assigned to a further one of the at least two brake circuits, for specifying brake pressures for actuating wheel brakes of the respective brake circuit. A first control unit is provided, which is configured to electrically modulate the respective control valve in dependence on an automatically requested vehicle setpoint deceleration or an actuation specified by the driver via a brake pedal. Furthermore, a second control unit is provided which is configured to control the parking brake valve electrically depending on the automatically requested vehicle setpoint deceleration if electrical actuation of the respective control valve is prevented in order to form an electronically pneumatically controlled redundancy. Furthermore, a bypass valve associated with one of the control valves is provided and is configured to pneumatically modulate the associated control valve, wherein the pneumatic modulation takes place in dependence on the automatically requested vehicle setpoint deceleration or in dependence on the brake pedal actuation performed by the driver if electrical actuation of the respective control valve is prevented.

However, such a configuration requires that the corresponding redundancy connection of the control valve, namely the front axle modulator or rear axle modulator, is functional. As a result, such a solution is dependent on one of the main actuators of the control valve, namely the front axle modulator or rear axle modulator, being functional.

There are also other approaches that create a fully redundant brake system, as disclosed in US 2022/0144232 and WO 2020/187569 in particular. According to the teaching there, all relevant system elements are duplicated and a fully redundant brake system is thus created. The brake systems are then combined via select high valves on the brake actuators. However, this solution has the fluidic disadvantage that the primary system can only modulate the brake pressure via the select high valves on the brake actuators, and therefore not directly. In addition, the complete duplication of the individual components also results in an increased installation space requirement.

### SUMMARY

The object of the present disclosure is therefore to further improve the existing systems, which basically function well, and to achieve a high level of availability while at the same time providing fluidically advantageous solutions that have fewer or no repercussions on the primary system.

The object is achieved in a first aspect of the disclosure in a redundancy valve assembly of the type mentioned at the outset in that the assembly has: a service brake pressure connection for receiving a service brake pressure from a service brake pressure modulator, a redundancy brake pressure connection for receiving a redundancy brake pressure from a redundancy brake pressure modulator, and a brake actuator connection for connecting at least one brake actuator, wherein the redundancy valve assembly is electrically actuatable in order to selectively modulate the service brake pressure or the redundancy brake pressure at the brake actuator connection.

In contrast to the prior art, in which one or more select high valves or other types of new shuttle valves are used to couple in a redundancy brake pressure in a service brake pressure path, for example directly on the brake actuator, and control through, purely mechanically, in particular the higher of two pressures applied to two different connections, the invention uses the redundancy valve assembly, which can be actuated electrically in order to modulate optionally the service brake pressure or the redundancy brake pressure at the brake pressure actuator connection. It is intended that the service brake pressure and the redundancy brake pressure are provided at two different connections of the redundancy valve assembly and are therefore, in particular, independent of each other. The service brake pressure is provided by a service brake pressure modulator and the redundancy brake pressure is provided by a redundancy brake pressure modulator. The modulation of the redundancy brake pressure via the redundancy valve assembly at the brake actuator connection is therefore not dependent on a main actuator of the service brake pressure modulator being functional. Rather, it is sufficient if the redundancy brake pressure modulator and the redundancy valve assembly are functional. An electrically actuatable redundancy valve assembly also makes it possible to modulate the service brake pressure or the redundancy brake pressure at the brake actuator connection independently of a possible fault. This means that, even in cases where there is no fault in the vehicle, the redundancy brake pressure can be modulated at a brake pressure actuator connection, for example to test the functionality, ensure the operability of valves, increase the service life of components, compensate for wear or implement other measures that positively influence efficiency, such as air consumption. In a first embodiment, the redundancy valve assembly has a solenoid valve unit which is connected at least to the service brake pressure connection and the redundancy brake pressure connection and is switchable by at least one first switching signal, wherein the service brake pressure or the redundancy brake pressure at the brake actuator connection is modulated in dependence on the at least first switching signal. The solenoid valve unit can preferably have one or more electromagnetically switchable valves, such as preferably monostable or bistable valves.

In an embodiment, the solenoid valve unit has an electromagnetic service pilot valve and an electromagnetic redundancy pilot valve, wherein the service pilot valve is switchable by the first switching signal and provides a first pilot pressure, and the redundancy pilot valve is switchable by a second switching signal and provides a second pilot pressure. One or more main valves can then be subsequently switched on the basis of the first and second pilot pressure in order to enable either the service brake pressure or the redundancy brake pressure to be controlled through to the brake actuator connection.

Preferably, the service pilot valve has a first service pilot valve connection connected to the service brake pressure connection, a second service pilot valve connection connected to the redundancy brake pressure connection, and a third service pilot valve connection modulating the first pilot pressure. Depending on the first switching signal, the service pilot valve connects either the first service pilot valve connection or the second service pilot valve connection to the third service pilot valve connection. Preferably, in a first switching position, the first service pilot valve connects the second service pilot valve connection to the third service pilot valve connection, and, in a second switching position, the first service pilot valve connects the first service pilot valve connection to the third service pilot valve connection. Preferably, the first service pilot valve is de energized in the first switching position.

The redundancy pilot valve is preferably configured in the same way as the service pilot valve. The redundancy pilot valve preferably has a first redundancy pilot valve connection connected to the redundancy pressure connection, a second redundancy pilot valve connection connected to the service brake pressure connection, and a third redundancy pilot valve connection that modulates the second pilot pressure. The redundancy pilot valve preferably connects either the first redundancy pilot valve connection or the second redundancy pilot valve connection to the third redundancy pilot valve connection, depending on the second switching signal. Preferably, the redundancy pilot valve connects the second redundancy pilot valve connection to the third redundancy pilot valve connection in a first switching position and the first redundancy pilot valve connection to the third redundancy pilot valve connection in a second switching position. Preferably, the redundancy pilot valve is de energized in the first switching position and is moved to the second switching position by providing the second switching signal. In one variant, the first or second pilot pressure can be modulated directly at the brake actuator connection as a volume pressure. In this respect, it can be provided that the service pilot valve and the redundancy pilot valve ultimately connect the service brake pressure connection or redundancy brake pressure connection directly to the brake actuator connection, and thus control the service brake pressure or redundancy brake pressure. The first pilot pressure then preferably corresponds to the service brake pressure and the second pilot pressure preferably corresponds to the redundancy brake pressure.

In an embodiment, however, it can also be provided that the redundancy valve assembly has a main valve unit which is connected to the service brake pressure connection, the redundancy brake pressure connection, and the brake actuator connection for optionally shutting out the service brake pressure or the redundancy brake pressure. This means that the main valve unit is preferably in a normally open switching position, so that, when the main valve unit is not actuated, the service brake pressure or redundancy brake pressure from the respective service brake pressure connections and redundancy brake pressure connection can be controlled through by the main valve unit and modulated at the brake actuator connection. The main valve unit can then be switched to either control the service brake pressure through to the brake actuator connection or to control the redundancy brake pressure through to the brake actuator connection. In the actuated state, at least one of these two pressures is preferably shut out.

The main valve unit preferably has a service main valve, which has a first service main valve connection connected to the service brake pressure connection and a second service main valve connection connected to the brake actuator connection. Preferably, the service main valve separates the first service main valve connection and the second service main valve connection in a blocking position and connects the first service main valve connection and the second service main valve connection by pressurized fluid in a passage position. Preferably, the main valve unit also has a redundancy main valve, which has a first redundancy main valve connection connected to the redundancy brake pressure connection and a second redundancy main valve connection connected to the brake actuator connection, wherein the redundancy main valve preferably separates the first redundancy main valve connection and the second redundancy main valve connection in a blocking position and connects the first redundancy main valve connection and the second redundancy main valve connection to one another by pressurized fluid in a passage position. The service main valve and the redundancy main valve can be of identical or different configuration, in one or two structural units.

Preferably, the service main valve is switchable pneumatically. For this purpose, the service main valve preferably has a service control connection which is connected to the solenoid valve unit to receive the first pilot pressure, wherein the service main valve is spring loaded into the blocking position. It may be provided that the service main valve switches from the blocking position to the release position when the first pilot pressure exceeds a certain first threshold value. It can also be provided that the service main valve switches from the release position to the closed position when the first pilot pressure exceeds a second threshold value. In order to form an operationally reliable fallback level, the service main valve should be configured so that it is in a release position when no first pilot pressure is being modulated but the service brake pressure is present at the service brake pressure connection. This is because the first pilot pressure can be modulated by actively switching the solenoid valve unit and the service brake pressure can be actively shut out in this way. In normal operation, however, the service main valve should be in a release position so that the service brake pressure can be controlled through and made available at the brake actuator connection in normal operation.

The same applies for the redundancy main valve. This is also preferably pneumatically switchable and preferably has a redundancy control connection. The redundancy control connection is preferably connected to the solenoid valve unit, in particular the redundancy pilot valve, to receive the second pilot pressure. Preferably, the redundancy main valve is spring loaded into the blocking position. In normal operation, the redundancy brake pressure should be shut out so that only the service brake pressure can be controlled through from the service brake pressure connection to the brake actuator connection. Only if the service brake pressure cannot be provided or cannot be provided correctly due to a fault should the service brake pressure connection be closed and the redundancy brake pressure should be controlled through and provided at the brake actuator connection.

In an embodiment, both the first switching signal and the second switching signal are provided by a redundancy control unit. This further develops the aspect of the operationally reliable fallback level. In the event that a fault occurs in a service level, a service level may not be able to provide the first switching signal or the second switching signal correctly or at all. If a redundancy level is then to take over control, the service brake pressure can be shut out and the redundancy brake pressure can be controlled through and provided at the brake actuator connection by a redundancy control unit providing the switching signals in the correct manner for operation.

In a further embodiment, an ABS valve is connected upstream of the service brake pressure connection so that an ABS modulated service brake pressure is provided to the service brake pressure connection. A conventional ABS valve can be provided here as an ABS valve, which reduces the service brake pressure depending on signals from one or more wheel speed sensors. In this case, an ABS modulated service brake pressure is a service brake pressure that is temporarily reduced by an ABS valve in accordance with this requirement in order to prevent a wheel from locking. By already providing an ABS modulated service brake pressure at the service brake pressure connection, in particular because an ABS valve is connected downstream of, or is integrated in, the service brake actuator, which controls the service brake pressure at the service brake pressure connection, the service brake pressure, which is modulated at the service brake pressure connection, can be controlled through by the redundancy valve assembly and modulated at the brake actuator connection and provided by this directly at the brake actuator, while at the same time preventing brake locking.

An ABS valve can also be connected upstream of the redundancy brake pressure connection in order to provide the redundancy brake pressure in ABS modulated form.

Additionally or alternatively, the redundancy valve assembly as a whole can also be configured as an ABS valve and can be provided to modulate the service brake pressure received at the service brake pressure connection in an ABS modulated manner at the brake actuator connection. For this purpose, the redundancy valve assembly can temporarily reduce the service brake pressure received at the service brake pressure connection in dependence on one or more signals from one or more wheel speed sensors in order to prevent a wheel from locking. For this purpose, the redundancy valve assembly can have one or more bleed valves that allow the service brake pressure to be reduced temporarily.

In a further embodiment, the redundancy valve assembly includes a rapid bleed valve for venting the pressure modulated at the brake actuator connection. The pressure modulated at the brake actuator connection can be the service brake pressure, the redundancy brake pressure, or a pressure derived from these. The pressure controlled at the brake actuator connection is preferably supplied directly to the brake actuator. By providing the redundancy valve assembly with a rapid bleed valve that is suitable for venting the pressure controlled at the brake actuator connection, it is possible on the one hand to quickly vent the brake actuator and thus quickly release the brake, and on the other hand to use the rapid bleed valve to achieve ABS control for only briefly and temporarily reducing the pressure modulated at the brake actuator connection.

Preferably, the rapid bleed valve is connected to the redundancy brake pressure connection in such a way that, optionally, the redundancy brake pressure can be modulated and the brake actuator connection can be vented via the rapid bleed valve. The rapid bleed valve therefore forms a venting path for the brake actuator connection, but allows the redundancy brake pressure to be modulated via this venting path of the brake actuator connection. The venting path of the brake actuator connection can then preferably be brought into connection with the service brake pressure connection or can be connected by pressurized fluid. The redundancy brake pressure can therefore be controlled via the venting path of the rapid bleed valve in order to be provided at the brake actuator connection in this way.

For this purpose, the rapid bleed valve could have a first rapid bleed valve connection connected to the redundancy brake pressure connection, a second rapid bleed valve connection connected to the main valve unit, and a third rapid bleed valve connection connected to a venting means.

In a further embodiment, it is provided that the service pilot valve is switchable by a third switching signal and the redundancy pilot valve is switchable by a fourth switching signal, which are provided by a service control unit. In this embodiment, the service pilot valve and the redundancy pilot valve are preferably Y wired, specifically both to the redundancy control unit and to the service control unit. This means that both the service pilot valve and the redundancy pilot valve can be switched independently of each other both by the redundancy control unit and by the service control unit. With regard to the service pilot valve and the redundancy pilot valve, the service control unit and the redundancy control unit can completely replace each other, so that the range of functions is increased.

In one variant, the service pilot valve can have a first electromagnet at which both the first switching signal and the third switching signal can be provided. Preferably, the redundancy pilot valve has a second electromagnet at which both the second switching signal and the fourth switching signal can be provided. The first, second, third and fourth switching signals are therefore each modulated at the same electromagnet and can both act on it.

Alternatively, it can also be provided that the service pilot valve has a first electromagnet at which the first switching signal can be provided and a third electromagnet at which the third switching signal can be provided. Preferably, the redundancy pilot valve analogously includes a second electromagnet at which the second switching signal can be provided and a fourth electromagnet at which the fourth switching signal can be provided. Each electromagnet is assigned its own switching signal here and, unlike in the example described above, a single electromagnet is not controlled with two switching signals. In this way, a better separation of functions can be achieved.

In a further embodiment, the solenoid valve unit has an electromagnetic inlet pilot valve and an electromagnetic outlet pilot valve, wherein the inlet pilot valve is switchable by an inlet switching signal and provides a third pilot pressure and the outlet pilot valve is switchable by an outlet switching signal and provides a fourth pilot pressure. Preferably, the inlet switching signal and the outlet switching signal are provided by a service control unit. The first switching signal and the second switching signal can also be provided by the redundancy control unit. In this respect, a redundancy valve assembly is created which has separate valves for the service level and the redundancy level, namely the service pilot valve and the redundancy pilot valve for the redundancy level and the inlet pilot valve and the outlet pilot valve for the service level.

It can be preferred here that the inlet pilot valve has a first inlet pilot valve connection connected to the service brake pressure connection, a second inlet pilot valve connection connected to a venting means, and a third inlet pilot valve connection that controls the third pilot pressure. The inlet pilot valve preferably connects either the first inlet pilot valve connection or the second inlet pilot valve connection to the third inlet pilot valve connection, depending on the inlet switching signal. Preferably, in a first switching position, the inlet pilot valve connects the second inlet pilot valve connection to the third inlet pilot valve connection, and in a second switching position, the first inlet pilot valve connection to the third inlet pilot valve connection. Preferably, the inlet pilot valve is de energized in the first switching position and switches to the second switching position when the inlet switching signal is provided.

Furthermore, the outlet pilot valve preferably has a first outlet pilot valve connection connected to a or the venting means, a second outlet pilot valve connection connected to the service brake pressure connection, and a third outlet pilot valve connection controlling the fourth pilot pressure. The outlet pilot valve preferably connects either the first outlet pilot valve connection or the second outlet pilot valve connection to the third outlet pilot valve connection, depending on the outlet switching signal. Preferably, the outlet pilot valve connects the second outlet pilot valve connection to the third outlet pilot valve connection in a first switching position, and the first outlet pilot valve connection to the third outlet pilot valve connection in a second switching position. Preferably, the outlet pilot valve is de-energized in the first switching position and switches to the second switching position when the outlet switching signal is provided.

Advantageously, in particular in embodiments with inlet and outlet pilot valves, it is further provided that the service pilot valve has a first service pilot valve connection connected to the service brake pressure connection, a second service pilot valve connection connected to a or the venting means, and a third service pilot valve connection controlling the first pilot pressure, wherein the service pilot valve connects either the first service pilot valve connection or the second service pilot valve connection to the third service pilot valve connection depending on the first switching signal. Preferably, the redundancy pilot valve has a first redundancy pilot valve connection connected to a or the venting means, a second redundancy pilot valve connection connected to the service brake pressure connection, and a third redundancy pilot valve connection controlling the second pilot pressure, wherein the redundancy pilot valve connects either the first redundancy pilot valve connection or the second redundancy pilot valve connection to the third redundancy pilot valve connection depending on the second switching signal.

In such embodiments, it is preferably further provided that the first pilot pressure and the third pilot pressure can be modulated via a first shuttle valve on the main valve unit, and/or the second pilot pressure and the fourth pilot pressure can be modulated via a second shuttle valve on the main valve unit. In this way, the pilot pressure modulated by the service pilot valve and the inlet pilot valve can be combined and provided alternately at the main valve unit, in particular and preferably at the service main valve. Similarly, the pilot pressures modulated by the redundancy pilot valve and outlet pilot valve can be combined and alternately controlled via the second shuttle valve on the main valve unit, specifically in particular on the redundancy main valve of the main valve unit. Since the first and second shuttle valves in this embodiment are only used to activate the main valves and thus basically switch between operating and redundancy mode, the performance and dynamics of the system do not suffer. In order to ensure the operability of the shuttle valves or even just to be able to test them, it is possible to actively switch between the different modes by providing the corresponding switching signals.

In a further embodiment, the redundancy valve assembly has a pressure sensor for detecting the pressure modulated at the brake actuator connection. In this way, it is possible to verify whether the main valve unit or the pilot valves of the redundancy valve assembly are functioning properly. A control loop can also be established in this way.

In a second aspect of the disclosure, the object mentioned at the outset is achieved in an electronically controllable pneumatic brake system for a vehicle, preferably a utility vehicle, having a service control unit for controlling the electronically controllable pneumatic brake system in an operating mode, at least one service axle modulator which is connected to the service control unit and receives service braking signals from the latter and controls a service brake pressure for a first axle on the basis thereof, a redundancy control unit for controlling the electronically controllable pneumatic brake system in the event of redundancy, and at least one redundancy axle modulator which is connected to the redundancy control unit and receives redundancy braking signals from the latter and controls a redundancy brake pressure for the first axle on the basis thereof, in that at least one redundancy valve assembly is provided according to one of the embodiments of a redundancy valve assembly according to the first aspect of the disclosure described above. In this case, the service brake pressure connection of the redundancy valve assembly is connected to the service axle modulator and receives the service brake pressure from the latter. The redundancy brake pressure connection is also connected to the redundancy axle modulator and receives the redundancy brake pressure from it. Lastly, the brake actuator connection of the redundancy valve assembly is connected to a first service brake actuator on the first axle.

It should be understood that the redundancy valve assembly according to the first aspect of the disclosure and the electronically controllable pneumatic brake system according to the second aspect of the disclosure have the same and similar sub aspects. In this respect, full reference is made to the above description of the redundancy valve assembly according to the first aspect of the disclosure for embodiments and their advantages.

Preferably, the at least one redundancy valve assembly is connected to the redundancy control unit and receives the first switching signal and the second switching signal from the redundancy control unit. It may also be provided that the redundancy valve assembly has its own intelligence and in this respect receives a request signal from the redundancy control unit, which then converts the redundancy valve assembly's own intelligence into the first and second switching signals. Furthermore, it is conceivable and preferred that the at least one redundancy valve assembly is integrated with the redundancy control unit to form a module.

Furthermore, the at least one redundancy valve assembly is preferably connected to the service control unit and receives the third and fourth switching signals from the latter. In the event that the redundancy valve assembly has an inlet pilot valve and an outlet pilot valve, it preferably also receives the inlet switching signal and the outlet switching signal from the service control unit. Again, it may be provided that the redundancy valve assembly has its own intelligence which determines these signals or is integrated with the service control unit to form a module.

In a further embodiment, it is provided that the electronically controllable pneumatic brake system has at least one first wheel speed sensor on the first axle, which is connected both to the service control unit and to the redundancy control unit and provides a first wheel speed signal to the latter. Preferably, the first switching signal and the second switching signal and possibly also further switching signals for the redundancy valve unit are generated and provided based on the first wheel speed signal. If further wheel speed sensors are present, these are also included. In this way, the redundancy valve unit can control the service brake pressure or redundancy brake pressure depending on the wheel speed and thus implement ABS functionality. Preferably, the third switching signal, the fourth switching signal, the inlet switching signal and/or the outlet switching signal are therefore also generated and provided by the service control unit based on the first wheel speed signal.

In an embodiment, the redundancy valve assembly is arranged on the first service brake actuator or installed adjacent to it. The redundancy valve assembly is preferably provided close to the wheel, and the first service brake actuator is preferably connected directly to the brake actuator connection of the redundancy valve assembly without further piping or tubing. In this way, high dynamics can be achieved and further fault sources can be avoided.

According to an embodiment, at least one redundancy valve assembly according to one of the embodiments of the redundancy valve assembly according to the first aspect of the disclosure described above is provided on each axle of the vehicle. In this way, axle based redundant braking can be achieved via the redundancy valve assembly of the vehicle. Preferably, a separate redundancy valve assembly is provided on each service brake actuator. In this way, the redundancy valve assembly can modulate the brake pressure redundantly for each wheel. It is also possible, for example, for a redundancy valve assembly to be provided on each service brake actuator on the front axle, wherein a single redundancy valve assembly is only provided for the rear axle. In the front axle, wheel oriented modulation would thus be permitted, while only axle oriented modulation is realized at the rear axle.

In an embodiment, a second redundancy valve assembly is provided, which is configured according to one of the embodiments of the redundancy valve assembly according to the first aspect of the disclosure described above, wherein the service brake pressure connection of the second redundancy valve assembly is connected to the service axle modulator and receives the service brake pressure from it and the redundancy brake pressure connection of the second redundancy valve assembly is connected to the redundancy axle modulator and receives the redundancy brake pressure from it. The brake actuator connection of the second redundancy valve assembly is preferably connected to at least one second service brake actuator on the first axle.

In a further embodiment, the electronically controllable pneumatic brake system also includes a second service axle modulator which is connected to the service control unit and receives service braking signals from the latter, and based thereon modulates a second service brake pressure for a second axle. Furthermore, the brake system includes a second redundancy axle modulator, which is connected to the redundancy control unit and receives redundancy braking signals from the latter and, based thereon, modulates a second redundancy brake pressure for the second axle. In this embodiment, the electronically controllable pneumatic brake system preferably has at least one third redundancy valve assembly according to one of the embodiments of a redundancy valve assembly according to the first aspect of the disclosure described above. Here, the service brake pressure connection of the third redundancy valve assembly is preferably connected to the second service axle modulator and receives the second service brake pressure from it, and the redundancy brake pressure connection of the third redundancy valve assembly is connected to the second redundancy axle modulator and receives the second redundancy brake pressure from it. Furthermore, the brake actuator connection of the third redundancy valve assembly is preferably connected to at least one third service brake actuator on the second axle. It can also be connected additionally to a fourth service brake actuator of the second axle or other service brake actuators on the second axle or another axle, such as a lift axle or the like.

In a third aspect, the disclosure achieves the above described object in a vehicle, preferably a utility vehicle of the above described type, including at least a first axle and a second axle and an electronically controllable pneumatic brake system, in that the electronically controllable pneumatic brake system is configured in accordance with one of the embodiments of the electronically controllable pneumatic brake system described above in accordance with the second aspect of the disclosure.

It should be understood that the electronically controllable pneumatic brake system according to the second aspect of the disclosure and the vehicle according to the third aspect of the disclosure have the same and similar sub aspects. In this respect, full reference is made to the above description for further embodiments and their advantages.

The disclosure achieves the object in a fourth aspect by a method for controlling an electronically controllable pneumatic brake system including the following steps: in an operating mode of the electronically controllable pneumatic brake system: modulating a service brake pressure by a service brake pressure modulator at a service brake pressure connection of a redundancy valve assembly, actuating the redundancy valve assembly by a service control unit based on first wheel speed signals and thereby preferably providing slip controlled modulation of the service brake pressure at a brake actuator connection of the redundancy valve assembly; and in a redundancy mode of the electronically controllable pneumatic brake system: modulating a redundancy brake pressure by a redundancy brake pressure axle modulator at a redundancy brake pressure connection of the redundancy valve assembly, and actuating the redundancy valve assembly by a redundancy control unit based on the first wheel speed signals and thereby preferably providing slip controlled modulation of the redundancy brake pressure at the brake actuator connection.

The method according to the fourth aspect of the disclosure is preferably implemented in an electronically controllable pneumatic brake system according to the second aspect of the disclosure. Preferably, the redundancy valve assembly referred to in the method according to the fourth aspect of the disclosure is a redundancy valve assembly according to one of the embodiments of a redundancy valve assembly according to the first aspect of the disclosure described above.

It should be understood that the method according to the fourth aspect of the disclosure, the redundancy valve assembly according to the first aspect of the disclosure and the electronically controllable pneumatic brake system according to the second aspect of the disclosure have the same and similar sub aspects. In this respect, full reference is made to the above description. In particular, functional features described above can also form method steps in the context of the method according to the fourth aspect of the disclosure and the functions described above can be implemented and executed in the context of the method.

### BRIEF DESCRIPTION OF DRAWINGS

The invention will now be described with reference to the drawings wherein:

FIG. 1 is a schematic representation of a redundancy valve assembly according to a first embodiment;

FIG. 2 is a schematic representation of a redundancy valve assembly including an ABS valve in a second embodiment;

FIG. 3 shows a redundancy valve assembly in a third embodiment;

FIG. 4 is a schematic representation of an electronically controllable pneumatic brake system according to an embodiment;

FIG. 5 shows a redundancy valve assembly according to a fourth embodiment;

FIG. 6 shows a redundancy valve assembly according to a fifth embodiment; and,

FIG. 7 shows a redundancy valve assembly according to a sixth embodiment.

### DETAILED DESCRIPTION

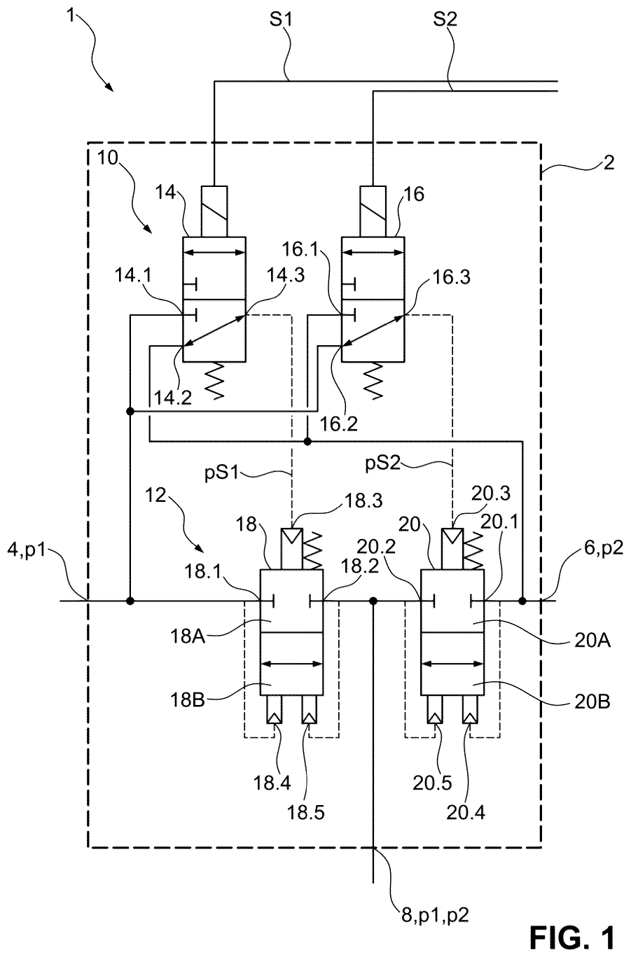

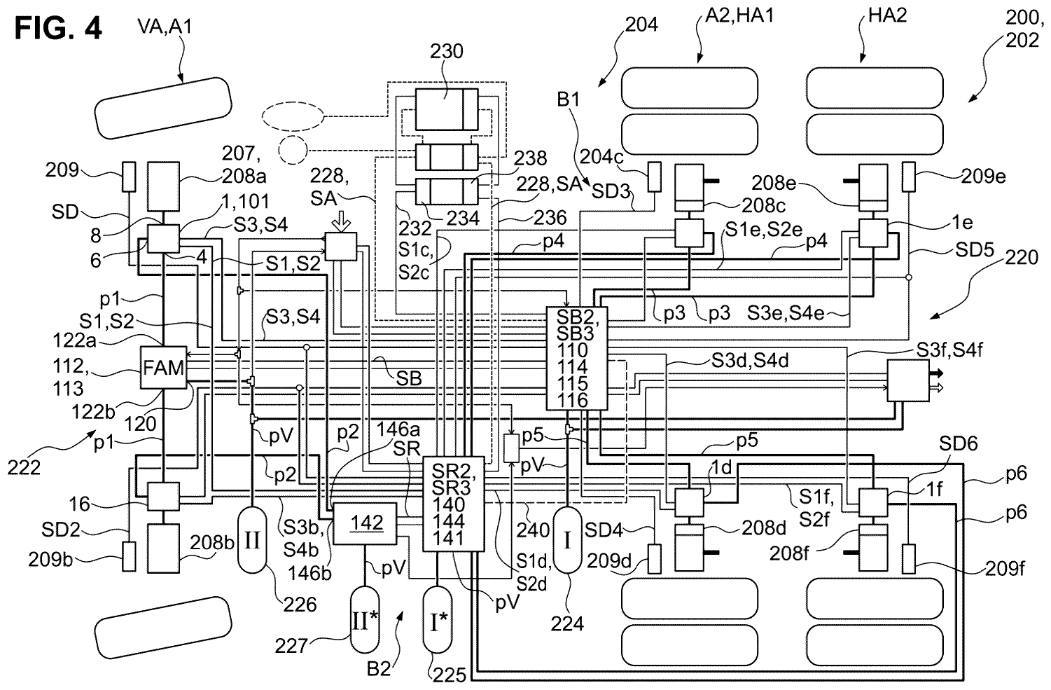

A redundancy valve assembly 1 for redundantly supplying a redundant brake pressure into a service brake pressure path of an electronically controllable pneumatic brake system 204 (cf. FIG. 4) has a service brake pressure connection 4, a redundancy brake pressure connection 6 and a brake actuator connection 8. Although a redundancy valve module housing 2 is indicated by the dashed line in FIG. 1, it should be understood that the individual components of the redundancy valve assembly 1 can also be installed separately in the vehicle, or integrated in other modules or in structural units, together, partially together or independently of each other. In this case, the service brake pressure connection 4, the redundancy brake pressure connection 6 and the brake actuator connection 8 can be arranged directly on individual components. In this respect, the illustration in the figures is only to be understood schematically. However, in the event that a redundancy valve module housing 2 is provided, the service brake pressure connection 4, the redundancy brake pressure connection 6 and the brake actuator connection 8 can be formed on this redundancy valve module housing 2.

A service brake pressure p1 is provided at the service brake pressure connection 4, as will be described in greater detail later with reference to FIG. 4. A redundancy brake pressure p2 is provided at the redundancy brake pressure connection 6, as will be described in greater detail later with reference to FIG. 4. One or more brake actuators can be connected to the brake actuator connection 8, as will be described in greater detail later with reference to FIG. 4. The redundancy valve assembly 1 modulates either the service brake pressure p1 received at the service brake pressure connection 4 or the redundancy brake pressure p2 received at the redundancy brake pressure connection 6 depending on certain signals (as will be described in greater detail later) at the brake actuator connection 8. Derived pressures can also be modulated from the pressures provided, depending on the configuration and switching position.

In the embodiment shown in FIG. 1, the redundancy valve assembly 1 includes a solenoid valve unit 10, which is connected to both the service brake pressure connection 4 and the redundancy brake pressure connection 6. The solenoid valve unit 10 receives a first switching signal S1 and a second switching signal S2. Depending on these first and second switching signals S1, S2, either the service brake pressure p1 or the redundancy brake pressure p2 is modulated at the brake actuator connection 8 according to the embodiment shown in FIG. 1.

Specifically, in the embodiment shown here, the solenoid valve unit 10 includes a service pilot valve 14, which is configured here as a monostable 3/2 way valve. The service pilot valve 14 includes a first service pilot valve connection 14.1, which is connected to the service brake pressure connection 4 and receives the service brake pressure p1 from it. The service pilot valve includes a second service pilot valve connection 14.2, which is connected to the redundancy brake pressure connection 6 and receives the redundancy brake pressure p2. The third service pilot valve connection 14.3 is connected to a main valve unit 12 in the embodiment shown here, but could also be connected to the brake actuator connection 8 in other embodiments. The service pilot valve 14 can alternately connect the first service pilot valve connection 14.1 or the second service pilot valve connection 14.2 to the third service pilot valve connection 14.3 and thus alternately modulate the service brake pressure p1 or the redundancy brake pressure p2 at the third service pilot valve connection 14.3. In the first switching position shown in FIG. 1, the second service pilot valve connection 14.2 is connected to the third service pilot valve connection 14.3, and in the second switching position, not shown in FIG. 1, the first service pilot valve connection 14.1 is connected to the third service pilot valve connection 14.3. The service pilot valve 14 is monostable in the first switching position shown in FIG. 1 and is moved to the second switching position, not shown in FIG. 1, when the first switching signal S1 is modulated.

Furthermore, the solenoid valve unit 10 includes a redundancy pilot valve 16. The redundancy pilot valve 16 is configured as a monostable 3/2 way valve and has a first redundancy pilot valve connection 16.1, which is connected to the redundancy brake pressure connection 6 and receives redundancy brake pressure p2 from it. A second redundancy pilot valve connection 16.2 is connected to the service brake pressure connection 4 and receives service brake pressure p1 from it. A third redundancy pilot valve connection 16.3 is connected to the main valve unit 12 in the embodiment shown in FIG. 1, but could also be connected to the brake actuator connection 8 directly or with the interposition of a valve. The redundancy pilot valve 16 alternately connects the first and second redundancy pilot valve connections 16.1, 16.2 to the third redundancy pilot valve connection 16.3. In a first switching position shown in FIG. 1, the second redundancy pilot valve connection 16.2 is connected to the third redundancy pilot valve connection 16.3, and in a second switching position, not shown in FIG. 1, the first redundancy pilot valve connection 16.1 is connected to the third redundancy pilot valve connection 16.3. The redundancy pilot valve 16 is stable and de energized in the first switching position shown in FIG. 1 and can be brought into the second switching position, not shown in FIG. 1, when the second switching signal S2 is modulated.

The main valve unit 12 is connected in such a way that when the service brake pressure p1 is modulated at the service brake pressure connection 4 and the service pilot valve 14 is simultaneously in the first switching position, the service brake pressure p1 is modulated at the brake actuator connection 8. Conversely, when the redundancy pilot valve 16 is in the first switching position and the service brake pressure p1 at the service brake pressure connection 4 is modulated, the redundancy brake pressure connection 6 is blocked so that the redundancy brake pressure p2 cannot be controlled through to the brake actuator connection 8. This prevents the pressures from being duplicated. The opposite can also be achieved by switching the service pilot valve 14 or redundancy pilot valve 16 to a different switching position.

In the embodiment shown here (FIG. 1), the main valve unit 12 includes a first service main valve 18, which is pneumatically configured. The service main valve is configured as a 2/2 way valve and includes a first service main valve connection 18.1 and a second service main valve connection 18.2, which are separated in a blocking position 18A and are pneumatically connected in a passage position 18B. The first service main valve connection 18.1 is connected to the service brake pressure connection 4 and receives service brake pressure p1 from it. The second service main valve connection 18.2 is connected to the brake actuator connection 8. A service control connection 18.3 is provided for switching the service main valve 18 from the blocking position 18A to the passage position 18B, and vice versa. The service control connection 18.3 receives a first control pressure pS1 from the solenoid valve unit 10. The first control pressure pS1 is modulated in dependence on the first and/or second switching signal S1, S2. In the embodiment shown in FIG. 1, the first control pressure pS1 is modulated by the service pilot valve 14. In the specific embodiment, the service control connection 18.3 is connected to the third service pilot valve connection 14.3 so as to receive the first pilot pressure pS1, which may correspond to the service brake pressure p1 or is a pressure derived therefrom. The service main valve 18 is spring loaded into the blocking position 18A. The service control connection 18.3 is also configured such that, if the first control pressure pS1 at the service control connection 18.3 exceeds a first threshold value, the service main valve 18 remains in the blocking position 18A and cannot be switched to the passage position 18B. A first service feedback connection 18.4, which receives the pressure applied to the service brake pressure connection 4, is provided to move the service main valve from the blocking position 18A to the passage position 18B. As soon as the pressure present at the service brake pressure connection 4, in particular the service brake pressure p1, exceeds a second predetermined threshold value, the service main valve 18 is switched from the blocking position 18A to the passage position 18B, overcoming the spring force of the spring preload. However, the service main valve 18 cannot be switched from the blocking position 18A to the passage position 18B if the first control pressure pS1 is present at the service control connection 18.3. The first and second threshold values are selected accordingly. In other words, the service main valve 18 is switched to the passage position 18B when, on the one hand, the service brake pressure p1 at the service brake pressure connection 4 is modulated and, on the other hand, the service pilot valve 14 is in the first switching position shown in FIG. 1, that is, the first switching signal S1 is not modulated. The service main valve 18 further includes a second service return connection 18.5, which returns the pressure modulated at the second service main valve connection 18.2 in order to realize a self holding function.

The redundancy main valve 20 is configured correspondingly to the service main valve 18. It is also configured as a pneumatically switchable 2/2 way valve and has a first redundancy main valve connection 20.1 and a second redundancy main valve connection 20.2, which are separated in a blocking position 20A and are pneumatically connected to each other in a passage position 20B. The first redundancy main valve connection 20.1 is connected to the redundancy brake pressure connection 6 and receives redundancy brake pressure p2 from it. The second redundancy main valve connection 20.2 is connected to the brake actuator connection 8 in order to be able to control the redundancy brake pressure p2 at this connection. The redundancy main valve 20 can be switched by a second control pressure pS2, which is provided by the solenoid valve unit 10, in dependence on the first and/or second switching signal S1, S2, from the blocking position 20A to the passage position 20B, and vice versa. The redundancy main valve 20 is spring loaded into the blocking position 20A. The redundancy main valve 20 also includes a first redundancy feedback connection 20.4, at which the pressure applied to the redundancy brake pressure connection 6, in particular the redundancy brake pressure p2, is modulated. If this exceeds a third threshold value, the redundancy main valve 20 can be switched from the blocking position 20A to the passage position 20B by overcoming the spring force of the return spring. However, if the second control pressure pS2 is simultaneously modulated at the redundancy control connection 20.3 and this exceeds a fourth threshold value, the redundancy main valve 20 cannot be switched to the passage position 20B, but remains in the blocking position 20A. In this way, the redundancy brake pressure p2 can be shut out. The second control pressure pS2 is then shut out when the service brake pressure p1 is shut out and the redundancy pilot valve 16 is simultaneously in the first switching position shown in FIG. 1.

In normal driving operation, the service brake pressure p1 should typically be modulated at the brake actuator connection 8. For this purpose, neither the first nor the second switching signal S1, S2 should be deactivated if possible, so that the service main valve 18 can switch to the passage position 18B and the redundancy main valve 20 remains in the blocking position 20A.

However, if the redundancy brake pressure p2 is now to be modulated at the brake actuator connection 8, at least the redundancy pilot valve 16 should be moved to the second switching position, not shown in FIG. 1. If the service brake pressure p1 is not modulated at the service brake pressure connection 4, the service main valve 18 is already moved to the blocking position 18A due to the spring preload. In order to ensure that the service main valve 18 remains in the blocking position 18A, the service pilot valve 14 should also be brought into the second switching position not shown in FIG. 1 by providing the first switching signal S1. The service brake pressure p1 can be vented either via the brake pressure modulator connected to the service brake pressure connection 4, or also by switching the redundancy main valve 20 via a redundancy modulator connected to the redundancy brake pressure connection 6.

The first and second switching signals S1, S2 are preferably provided by a redundancy control unit, but can also be provided by a service control unit, or the first switching signal S1 is provided in a service control unit and the second switching signal S2 is provided by a redundancy control unit, or vice versa. The service pilot valve 14 and the redundancy pilot valve 16 can be supplied by one or two independent voltage sources, or are both supplied with voltage redundantly. It can also be provided that the service brake pressure p1 and the redundancy brake pressure p2 are supplied from the same or from two different, preferably independent, compressed air supplies.

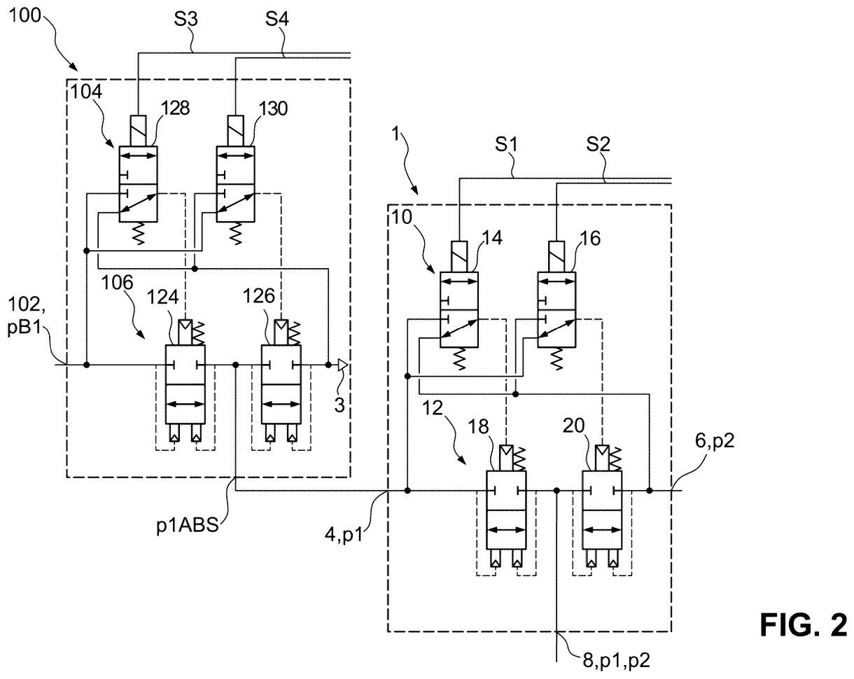

FIG. 2 shows an embodiment with a redundancy valve assembly 1 according to the first embodiment shown in FIG. 1, wherein an ABS valve 100 is connected upstream of the service brake pressure connection 4. The ABS valve 100 can be configured as a conventional ABS valve, as is known in the prior art, and has a brake modulator connection 102, at which a first brake pressure pB1 can be provided, which is then controlled by the ABS valve 100 as an ABS modulated service brake pressure p1ABS. An ABS modulated service brake pressure p1ABS is slip controlled.

The ABS valve 100 has an ABS pilot control unit 104 and an ABS main valve unit 106. The ABS pilot control unit 104 receives a third and a fourth switching signal S3, S4, which are modulated based on wheel speed signals. The ABS main valve unit 106 includes an ABS inlet valve 124 and an ABS outlet valve 126, which are pneumatically controlled. The ABS inlet valve 124 is connected to the brake modulator connection 102 and can modulate the ABS modulated service brake pressure p1ABS by switching. The ABS outlet valve 126 is also pneumatically controlled and connected to a venting means 3 in order to vent the ABS modulated service brake pressure p1ABS or also the service brake pressure p1 if this is not ABS modulated. For this purpose, the ABS outlet valve 126 is then switched to a passage position. The ABS inlet valve 124 and the ABS outlet valve 126 are switched based on the ABS pilot control unit 104, which in the embodiment shown in FIG. 2 has an ABS inlet pilot valve 128 and an ABS outlet pilot valve 130.

In addition to the advantage that an ABS modulated service brake pressure p1ABS can be provided at the service brake pressure connection 4, the ABS valve 100 also has the advantage that the service brake pressure p1 can be vented via the venting means 3 of the ABS valve 100. This is relevant if compressed air from the brake pressure actuator, which is connected to the brake actuator connection 8, is to be vented in order to reduce the braking force.

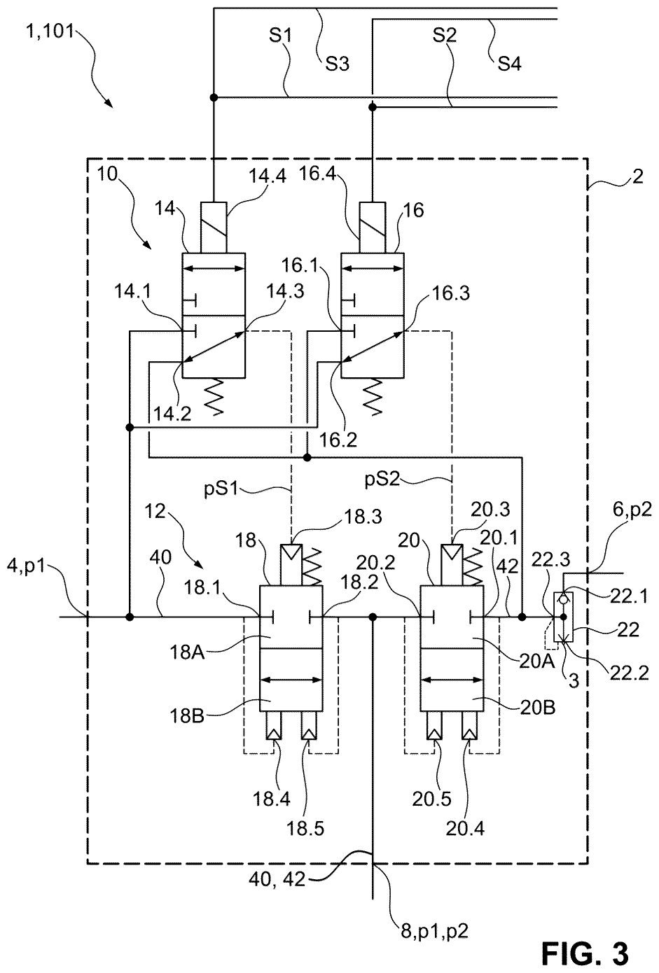

In the embodiment shown in FIG. 3, the redundancy valve assembly 1 is again configured substantially according to the embodiment shown in FIG. 1 and the same and similar elements are provided with the same reference signs, so that reference is made in full to the above description. In contrast to the first embodiment (FIG. 1), the redundancy valve assembly 1 in the third embodiment (FIG. 3) is configured as an ABS valve 101.

While the ABS valve 100 was connected upstream of the service brake connection 4 in the second embodiment shown in FIG. 2, the redundancy valve assembly 1 in the embodiment shown in FIG. 3 is configured in such a way that it can also perform an ABS functionality. For this purpose, the service pilot valve 14 and the redundancy pilot valve 16 are initially wired in such a way that not only the first or second switching signals S1, S2, which are preferably modulated by a redundancy control unit 140 (cf. FIG. 4), can be provided, but also the third and fourth switching signals S3, S4, which are preferably provided by a service control unit 110 (cf. FIG. 4). The third and fourth switching signals S3, S4 are switching signals that are modulated based on wheel speed sensor signals and can therefore also be referred to as ABS signals. They are used to modulate the service brake pressure p1, which is provided to the service brake connection 4 by a service brake modulator, in such a way that an ABS modulated or slip controlled service brake pressure p1, p1ABS is modulated at the brake actuator connection 8. For this purpose, the service brake pressure p1 provided at the service brake connection 4 must be partially vented, that is, the pressure modulated at the brake actuator connection 8 must be temporarily reduced in order to release a brake actuator connected to the brake actuator connection 8 and prevent wheels from locking. For this purpose, in the third embodiment (FIG. 3), the service pilot valve 14 and the redundancy pilot valve 16 can not only be actuated by the first and second switching signals S1, S2 in such a way that the redundancy brake pressure p2 can be shut out and the service brake pressure p1 can be controlled through during operation of the vehicle, but also the service pilot valve 14 and the redundancy pilot valve 16 can be actuated by the third and fourth switching signals S3, S4 in such a way that the pressure applied to the brake actuator connection 8 is temporarily reduced in order to release a brake actuator connected to it. This can be done with reference to both the service brake pressure p1 and the redundancy brake pressure p2. This means that both the service brake pressure p1 and the redundancy brake pressure p2 can be ABS modulated or slip controlled. If only one of the third and fourth switching signals S3, S4 is provided, only one of the service brake pressure p1 and the redundancy brake pressure p2 can be modulated in a slip controlled manner.

In order to be able to vent the brake actuator connection 8, a rapid bleed valve 22 is advantageously provided in the embodiment shown here, which is integrated into the redundancy valve module housing 2 in the embodiment shown in FIG. 3, but could also be arranged externally to it. Specifically, in the embodiment shown here (FIG. 3), the rapid bleed valve 22 is connected between the redundancy brake pressure connection 6 and the main valve unit 12, more precisely the second redundancy main valve connection 20.2. The rapid bleed valve 22 includes a first rapid bleed valve connection 22.1, a second rapid bleed valve connection 22.2 and a third rapid bleed valve connection 22.3. The first rapid bleed valve connection 22.1 is connected to the redundancy brake pressure connection 6 and thus receives redundancy brake pressure p2 from it. The second rapid bleed valve connection 22.2 is connected to a venting means 3 and the third rapid bleed valve connection 22.3 is connected to the second redundancy main valve connection 20.2. The rapid bleed valve 22 is configured such that it always connects the second to the third rapid bleed valve connection 22.2, 22.3 in the unactuated and depressurized state, so that the second redundancy main valve connection 20.2 is connected to the venting means 3 in this unactuated state. The brake actuator connection 8 can therefore be vented via the redundancy main valve 20. The redundancy main valve 20 thus assumes the function of the ABS bleed valve 110 according to FIG. 2 when it is vented by venting the redundancy control connection 20.3 by switching the redundancy pilot valve 16 to the second switching position, not shown in FIG. 3, by the fourth switching signal S4. In the second switching position of the redundancy pilot valve 16, which here also assumes the function of the ABS outlet pilot valve 114, the third redundancy pilot valve connection 16.3 is connected to the first redundancy pilot valve connection 16.1, which in turn is connected to the third rapid bleed valve connection 22.2 via lines and is thus also connected to the exhaust 3. If the redundancy control connection 20.3 is vented and a service brake pressure p1 is present at the brake actuator connection 8, this is also modulated at the second redundancy feedback connection 20.5, so that the redundancy main valve 20 is switched to the passage position 20B. As a result, the brake actuator connection 8 is vented, at least until either the spring load of the redundancy main valve 20 switches it back to the blocking position 20A or the fourth switching signal S4 is no longer provided.

In this case, the redundancy brake pressure p2 can be modulated via the first rapid bleed valve connection 22.1, which is closed by a valve element during normal operation. This valve element then comes out of its blocking position when the redundancy brake pressure p2 is provided and the valve element is thereby pressed into a passage position. The service brake pressure p1 can then flow from the first rapid bleed valve connection 22.1 to the third rapid bleed valve connection 22.3 and from there, via the redundancy main valve 20, which is then switched to the passage position 20B, due to the modulation of the redundancy brake pressure p2 at the first redundancy feedback connection 20.4, at the brake actuator connection 8. Reference sign 40 in FIG. 3 indicates a service brake pressure path that runs from the service brake pressure connection 4 to the brake actuator connection 8. Reference sign 42 indicates a venting path that runs from the brake actuator connection 8 to the venting means 3 on the second rapid bleed valve connection 22.2. The redundancy brake pressure p2 can therefore be fed into the service brake pressure path 40 via the redundancy brake pressure connection 6 via a venting path.

FIG. 4 now illustrates the use of the redundancy valve assembly 1 in an electronically controllable pneumatic brake system 204. The electronically controllable pneumatic brake system 204 is provided here for a vehicle 200, namely a utility vehicle 202, which has a first axle A1, which is a front axle VA, a second axle A2, which is here a first rear axle, and a second rear axle A2. The electronically controllable pneumatic brake system 204 has a first service brake actuator 207, which is here a first front axle brake actuator 208a, as well as second, third, fourth, fifth and sixth service brake actuators 208a 208f for one wheel each. A rear axle brake circuit 220 and a front axle brake circuit 222 are provided for supplying the first to eighth service brake actuators 208a 208f. The rear axle brake circuit 220 is supplied by a first service compressed air supply 224 and the front axle brake circuit 222 is supplied by a second service compressed air supply 226.

The electronically controllable pneumatic brake system 204 has a service level B1 and at least one first redundancy level B2.

In the service level B1, the electronically controllable pneumatic brake system 204 includes an electronic service control unit 110 that controls the electronically controllable pneumatic brake system 204 in the service level B1. The electronic service control unit 110 is connected to an autonomous driving unit 230 via a vehicle BUS 228 and receives brake request signals SA from the autonomous driving unit. In addition, the service control unit 110 is connected to a first voltage source 234 via a first supply line 232 and is supplied with electrical voltage by the first voltage source. The electronic service control unit 110 converts the brake request signals SA and, based thereon, modulates service braking signals SB at a first service axle modulator 112, which is configured here as a front axle modulator 113. The first service axle modulator 112 is provided here for the first axle A1, namely the front axle VA, and can thus also be referred to as the front axle modulator 113. The first service axle modulator 112 is connected to the second service compressed air supply 226 and receives supply pressure pV from it. Specifically, the supply pressure pV is provided at a first supply connection 120 of the first service axle modulator 112. Based on the received service braking signals SB, the first service axle modulator 112 controls a first service brake pressure p1 at a first service brake pressure output 122a and a second service brake pressure output 122b. However, the first and second service brake pressure outputs 122a, 122b are only shown separately in FIG. 4 and can actually be connected within the first service axle modulator 112, so that this is configured as a so called single channel modulator. It modulates the service brake pressure p1 both at the first service brake pressure output 122a and at the second service brake pressure output 122b. In other embodiments, however, the first service axle modulator 112 can also be configured as a dual channel axle modulator, so that wheel oriented and side oriented pressures are modulated at the first and second service brake pressure outputs 122a, 122b.

A redundancy valve assembly 1 according to the disclosure is provided on the right hand side in the direction of travel, connected to the first service brake pressure output 122a. This receives the service brake pressure p1 and modulates this to the first service brake actuator 207 or the first service brake actuator 208a in the event of operation. Specifically, the redundancy valve assembly 1 is configured here as an ABS valve 101 according to the embodiment of FIG. 3 described above, so that it can also implement an ABS functionality, as is basically known from vehicles. Such ABS functionalities are described, for example, in U.S. Pat. No. 5,118,169, US 2022/0144235 and DE 10 2019 131 128 A1, to the disclosure content of which reference is made here and which is hereby incorporated by reference.

A first wheel speed sensor 209 is also provided on the first axle A1, in this case the front axle VA, which provides first wheel speed signals SD to the service control unit 110. The service control unit 110 is configured to process the first wheel speed signals SD and to provide the third and fourth switching signals to the redundancy valve assembly 1 in order to achieve slip control or ABS modulation of the service brake pressure p1 and to prevent the front right wheel of the vehicle 200 from locking.

In the embodiment shown in FIG. 4, a second redundancy valve assembly 1b is provided for the left hand side of the vehicle on the first axle A1, namely the front axle VA, which is preferably configured identically to the first redundancy valve assembly 1 and also receives the service brake pressure p1 from the first service axle modulator 112, namely via the second service brake pressure output 122b. The second redundancy valve assembly 1b is also connected to the service control unit 110 in a signal conducting manner and receives switching signals from the latter, which are generated in dependence on second wheel speed signals SD2 of a second wheel speed sensor 209b.

Power is supplied to the redundancy valve assembly 1 and the second redundancy valve assembly 1b with respect to the third and fourth switching signals S3, S4 via the first voltage source 234 in the embodiment shown here.

In order to brake the second axle A2 or the first and second rear axles HA1, HA2, the electronically controllable pneumatic brake system 204 in the service plane B1 includes a second service axle modulator 114, which is provided here for the first and second rear axles HA1, HA2 and can thus also be referred to as rear axle modulator 115. In the embodiment shown in FIG. 4, the second service axle modulator 114 is installed with the electronic service control unit 110 to form a module, which is referred to here as the central module 116. However, it should be understood that the second service axle modulator 114 and the service control unit 110 can also be structurally separate and can then be connected to each other, for example, via a signal line or a BUS line. Internally, the electronic service control unit 110 controls second and third service braking signals SB2, SB3 at the second service axle modulator 114 in accordance with the brake request signals SA received by the service control unit 110 from the autonomous driving unit 230.

The second service axle modulator 114 is connected to the first service compressed air supply 224 and receives supply pressure pV therefrom. In accordance with the second and third service braking signals SB2, SB3, the second service axle modulator 114 modulates at least a second service brake pressure p3, but in the embodiment shown here it also modulates a third service brake pressure p5. In the embodiment shown in FIG. 4, the second service brake pressure p3 is provided for the right hand side of the vehicle and the third service brake pressure p5 is provided for the left hand side of the vehicle. The second service axle modulator 114, which functions here as the rear axle modulator 115, can therefore be described as a dual channel axle modulator. The second service brake pressure p3 is intended for a third and fifth service brake actuator 208c, 208e, while the third service brake pressure p5 is intended for a fourth and a sixth service brake actuator 208d, 208f.

In the embodiment shown in FIG. 4, a redundancy valve assembly according to the disclosure is connected upstream of each of the third, fourth, fifth and sixth service brake actuators 208c 208f. A third redundancy valve assembly 1c is provided close to the wheel and directly upstream of the fourth service brake actuator 208c, a fourth redundancy valve assembly 1d is provided close to the wheel and upstream of the fourth service brake actuator 208d, a fifth redundancy valve assembly 1e is provided close to the wheel and upstream of the fifth service brake actuator 208e, and a sixth redundancy valve assembly 1f is provided close to the wheel and upstream of the sixth service brake actuator 208f. The fourth to sixth redundancy valve assemblies 1c 1f are all identical to the redundancy valve assembly 1, 101, as described above. In deviation from this, only the third redundancy valve assembly 1c and the fifth redundancy valve assembly 1e are provided with the second service brake pressure p3 instead of the service brake pressure p1, and the fourth redundancy valve assembly 1d and the sixth redundancy valve assembly 1f are provided with the third service brake pressure p5 in deviation from this.

Third to sixth wheel speed sensors 209c 209f are also provided on the first and second rear axles HA1, HA2 and respectively provide third to sixth wheel speed signals SD3, SD4, SD5, SD6 to the service control unit 110. This processes the third to sixth wheel speed signals SD3, SD4, SD5, SD6 and controls corresponding third and fourth switching signals S3, S4, as described above with reference to the redundancy valve assembly 1, also at the third to sixth redundancy valve assembly 1c 1f, but these are then dependent on the third to sixth wheel speed signals SD3 SD6. The corresponding third and fourth switching signals S3, S4 are referred to below as S3c S3f and S4c S4f. In this way, the second and third service brake pressures p3, p5 can be slip controlled or ABS modulated at the third to fifth service brake actuators 208c 208f in order to prevent the corresponding wheels from locking.

In the redundancy level B2, the electronically controllable pneumatic brake system 204 includes a redundancy control unit 140 which is intended to control the electronically controllable pneumatic brake system 204 in the event that the service level B1 has one or more faults, for example in the event of a power failure in the first voltage source 234, an electronic fault in the service control unit 110 or the like. The electronic redundancy control unit 140 is also connected to the autonomous driving unit 230 via the vehicle BUS 228 and also receives brake request signals SA from the latter. In contrast to the service control unit 110, the redundancy control unit 140 is connected to a second voltage source 238 via a second supply line 236 and is supplied with electrical voltage from this. The first and second voltage sources 234, 238 are independent of each other, so that a failure in the first voltage source 234 does not lead to a loss of the second voltage source 238, and vice versa. The electronic service control unit 110 and the electronic redundancy control unit 140 are therefore electrically independent of each other.

In order to be able to exchange signals, the service control unit 110 and the redundancy control unit 140 are connected to one another via a redundancy BUS 240. In this way, the redundancy control unit 140 can determine the availability of the service control unit 110 and only take over control of the electronically controllable pneumatic brake system 240 if the service control unit 110 is not available or no longer properly available. The service control unit 110 can also cause the redundancy control unit 140 to carry out one or more tests, in particular to modulate the redundancy pressure described above, in order to maintain the operability of valves and thus increase availability.

A redundancy axle modulator 142 is provided in the redundancy level B2 and is connected to the redundancy control unit 140 and receives redundancy braking signals SR from the latter. The redundancy axle modulator 142 is connected to a further second service compressed air supply 227, which is independent of the second service compressed air supply 226, so that the further second service compressed air supply 227 can also provide supply pressure pV if, for example, the second service compressed air supply 226 has failed. In other embodiments, however, the redundancy axle modulator 142 can also be connected to the second service compressed air supply 226 or the first service compressed air supply 224.

The redundancy axle modulator 142 controls a redundancy brake pressure p2 at a first redundancy brake pressure output 146a and a second redundancy brake pressure output 146b in dependence on the redundancy braking signals SR. The redundancy brake pressure p2 modulated at the first redundancy brake pressure output 146a is provided to the redundancy brake pressure connection 6 of the redundancy valve assembly 1. The redundancy brake pressure modulated at the second redundancy brake pressure output 146b is provided to the second redundancy valve assembly 1b on the left side of the front axle VA. The redundancy axle modulator 142 is again configured as a single channel axle modulator and the first and second redundancy brake pressure outputs 146a, 146b are shown separately in FIG. 4, but can also be configured as one output. In other embodiments, not shown here, the redundancy axle modulator 142 is configured as a dual channel axle modulator and can thus realize a side by side control of redundancy brake pressures.

The redundancy valve assembly 1 is connected to the redundancy control unit 140 and receives the first and second switching signals S1, S2 from the latter. In this way, the redundancy valve assembly 1 can be actuated by the redundancy control unit 140 in such a way that the redundancy brake pressure p2, which is modulated at the redundancy brake pressure connection 6, is controlled through and provided at the first service brake actuator 207. As can be seen in FIG. 4, the redundancy control unit 140 is additionally connected to the first wheel speed sensor 209 and thus also receives the first wheel speed signals SD. In this respect, it is also preferred that the redundancy control unit 140 modulates the first and second switching signals S1, S2 in dependence on the first wheel speed signals SD in order to enable slip control or ABS modulation of the redundancy brake pressure p2. The same explanations also apply to the further redundancy valve assembly 1b on the left hand side of the vehicle. The redundancy control unit 140 is also connected to the second wheel speed sensor 209 and the redundancy brake pressure p2 can be provided to the second service brake actuator 208b via the second redundancy valve assembly 1b.

In order to now also be able to brake the first and second rear axles HA1, HA2 of the vehicle 200 redundantly, the electronically controllable pneumatic brake system 204 in the redundancy level B2 also includes a second redundancy axle modulator 144, which is intended to replace the second service axle modulator 114. In the embodiment shown here (FIG. 4), the second redundancy axle modulator 144 is integrated with the redundancy control unit 140 in a redundancy module 141, similarly to what was described above with reference to the central module 116. In this respect, the redundancy control unit 140 also provides second and third redundancy braking signals SR2, SR3 at the redundancy axle modulator 144. The second redundancy axle modulator 144 is connected to a further first service compressed air supply 225 and receives supply pressure pV from it. The first service compressed air supply 224 and the further first service compressed air supply 225 are independent of each other, so that a failure of the first service compressed air supply 224 does not result in the second redundancy axle modulator 144 no longer being supplied with supply pressure pV. In other embodiments, however, the second redundancy axle modulator 144 may also be connected to the first service compressed air supply 224, the second service compressed air supply 226 or the further second service compressed air supply 227 in order to receive supply pressure pV.

The second redundancy axle modulator 144 modulates a second redundancy brake pressure p4 for the second axle A2. In addition, it also modulates a third redundancy brake pressure p6 for the second axle, in this case the first rear axle HAL. The second redundancy brake pressure p4 is intended for the right hand side of the vehicle and the third redundancy brake pressure p6 for the left hand side of the vehicle. In this respect, the second redundancy brake pressure p4 replaces the second service brake pressure p3 and the third redundancy brake pressure p6 replaces the third service brake pressure p5. The second and third redundancy brake pressures are provided at corresponding brake pressure connections of the fourth to sixth redundancy valve units 1c 1f, in accordance with the embodiments of the redundancy valve units described above. The redundancy control unit 140 also receives the third to sixth wheel speed signals SD3 SD6 of the third to sixth wheel speed sensors 209c 209f and modulates corresponding first and second switching signals, hereinafter referred to as S1c S1f, S2c S2f at the corresponding third to fourth redundancy valve units 1c 1f. The corresponding brake actuator connections (not provided with reference signs in FIG. 4) of the third to fourth redundancy valve units 1c 1f are then in turn connected to the corresponding third to fourth service brake actuators 208c 208f.

The service brake actuators 208a 208f can be vented as described above via the corresponding redundancy valve units 1c 1f.

Furthermore, the electronically controllable pneumatic brake system 204 is implemented with an additional redundancy level that functions purely pneumatically, as described, for example, in US 2020/0023827, in US 2022/0144232, in US 2022/0185251 or US 2022/0089137.

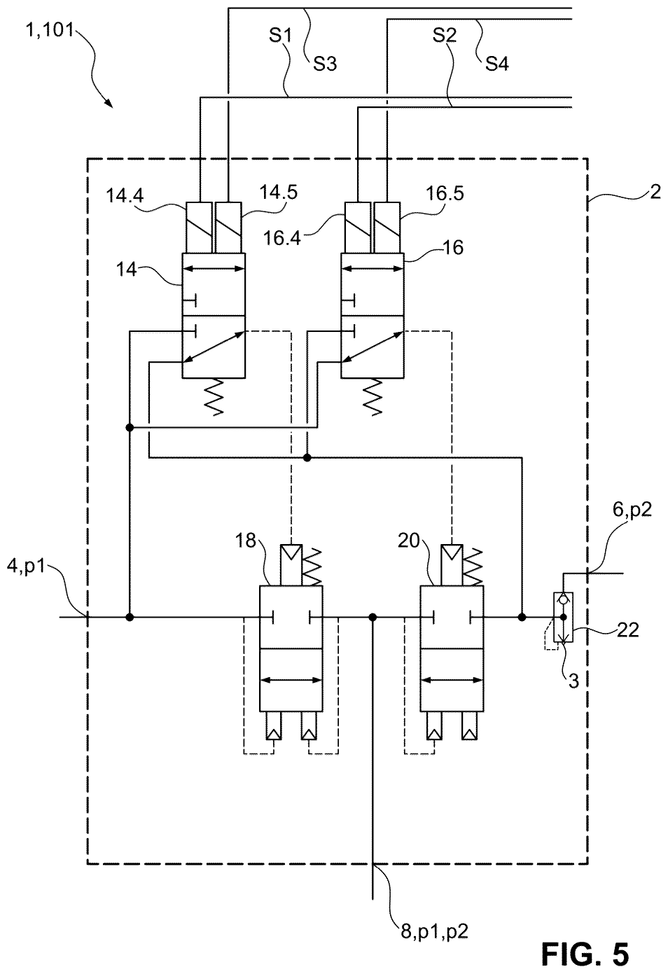

FIG. 5 now shows an alternative embodiment to the embodiment shown in FIG. 3. Identical and similar elements are provided with the same reference signs, so that full reference is made to the above description. In the following, the differences to the embodiment shown in FIG. 3 are highlighted in particular, so that the similarities are not discussed further.

A significant difference in the embodiment shown in FIG. 5 is that the first and third switching signals S1, S3 as well as the second and fourth switching signals S2, S4 are not provided at a first electromagnet 14.4 of the service pilot valve or a second electromagnet 16.4 of the redundancy pilot valve 16, but in the embodiment according to FIG. 5 the service pilot valve 14 also has a third electromagnet 14.5 in addition to the first electromagnet 14.4, and the redundancy pilot valve 16 also has a fourth electromagnet 16.5 in addition to the second electromagnet 16.4. The first switching signal S1 is only provided at the first electromagnet 14.4, the second switching signal S2 is only provided at the second electromagnet 16.4, the third switching signal S3 is only provided at the third electromagnet 14.5, and the fourth switching signal S4 is only provided at the fourth electromagnet 16.5.

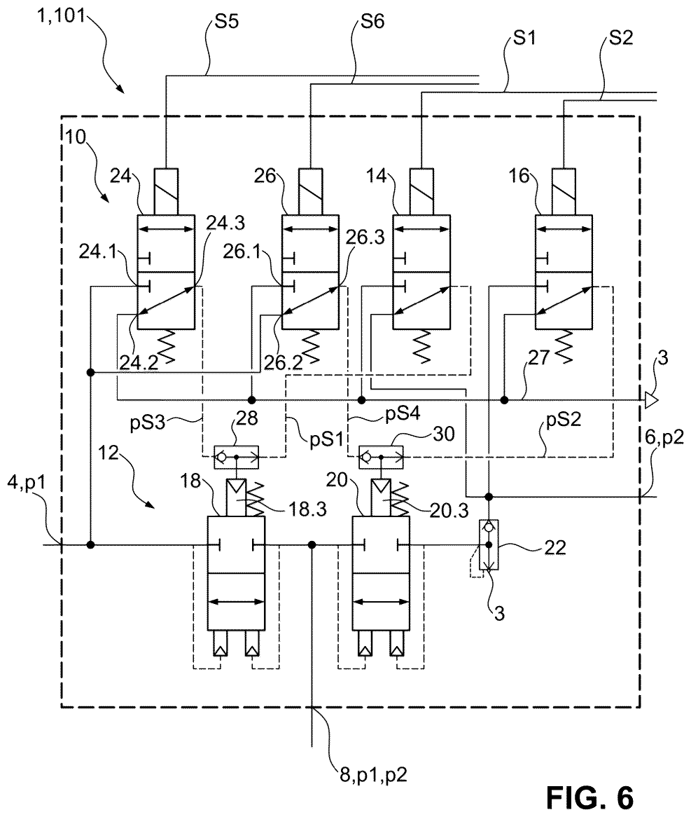

FIG. 6 shows a further alternative embodiment, which is basically also based on the embodiments in FIGS. 2, 3 and 5. In the embodiment shown in FIG. 6, the same and similar elements are again provided with the same reference signs, so that reference is made in full to the above description. In the following, the differences from the previous embodiments are described in particular, while similarities are not further emphasized.

A significant difference to the embodiment shown in FIG. 5 is that not only are the electromagnets doubled up, but the solenoid valve unit 10 also includes doubled up pilot valves. In addition to the service pilot valve 14 and the redundancy pilot valve 16, the embodiment shown here (FIG. 6) also includes an inlet pilot valve 24 and an outlet pilot valve 26. The inlet pilot valve 24 is configured as a monostable 3/2 way solenoid valve with a first inlet pilot valve connection 24.1, which is connected to the service brake pressure connection 4 and receives the service brake pressure p1 from this. A second inlet pilot valve connection 24.2 is connected to a or the venting means 3 via a venting path 28 provided separately here, and a third inlet pilot valve connection 24.3 is connected to the main valve unit. In a first switching position shown in FIG. 6, the second inlet pilot valve connection is connected to the third inlet pilot valve connection, and in a second switching position, not shown in FIG. 6, the first inlet pilot valve connection 24.1 is connected to the third inlet pilot valve connection 24.3, so that a third control pressure pS3 is modulated at the third inlet pilot valve connection 24.3 and can correspond to the service brake pressure p1 or a pressure derived therefrom. The switching of the inlet pilot valve 24 from the first to the second switching position is effected by a fifth switching signal S5, which is preferably provided by the service control unit 110.

In order to control the first and third control pressure pS1, pS3 at the main valve unit 12, more precisely at the service main valve 18 and there at the service control connection 18.3, a first shuttle valve 28 is provided, which modulates the higher of the first and third control pressure pS1, pS3 at the service control connection 18.3. In the embodiment shown here, the first control pressure pS1 is also vented by the separate venting path 27, but could also be vented via the rapid bleed valve 22.

In addition, the outlet pilot valve 26 is also configured as a monostable 3/2 way solenoid valve, with a first outlet pilot valve connection 26.1, which is connected here to the separate venting path 27 and thus to the venting means 3, a second outlet pilot valve connection 26.2, which is connected to the service brake pressure connection 4 and receives service brake pressure p1, and a third outlet pilot valve connection 26.3, which is connected to the main valve unit 12. In the first monostable switching position shown in FIG. 6, the second outlet pilot valve connection is connected to the third outlet pilot valve connection, and in the second switching position, not shown in FIG. 6, the first outlet pilot valve connection 26.1 is connected to the third outlet pilot valve connection 26.3, so that in this switching state the fourth control pressure pS4 is modulated, which can correspond to the service brake pressure p1 or a pressure derived therefrom. The outlet pilot valve 26 is switched from the first to the second switching position by a sixth switching signal S6, which is preferably provided by the service control unit 110. Again, a second shuttle valve 30 is provided for combining the fourth and the second control pressure pS2, pS4 and respectively controls the higher of the second and fourth control pressure pS2, pS4 at the main valve unit 12, in the embodiment shown here more precisely at the redundancy main valve 20, namely at the redundancy control connection 20.3 of the redundancy main valve 20. The venting of the second control pressure pS2 also takes place here via the separate venting path 27, unlike in the previous embodiments, but could also still take place via the rapid bleed valve 22. By way of the embodiment shown in FIG. 6, redundancy is also achieved in the valves, whereas in an embodiment shown in FIG. 5, redundancy is only achieved in the six magnets.

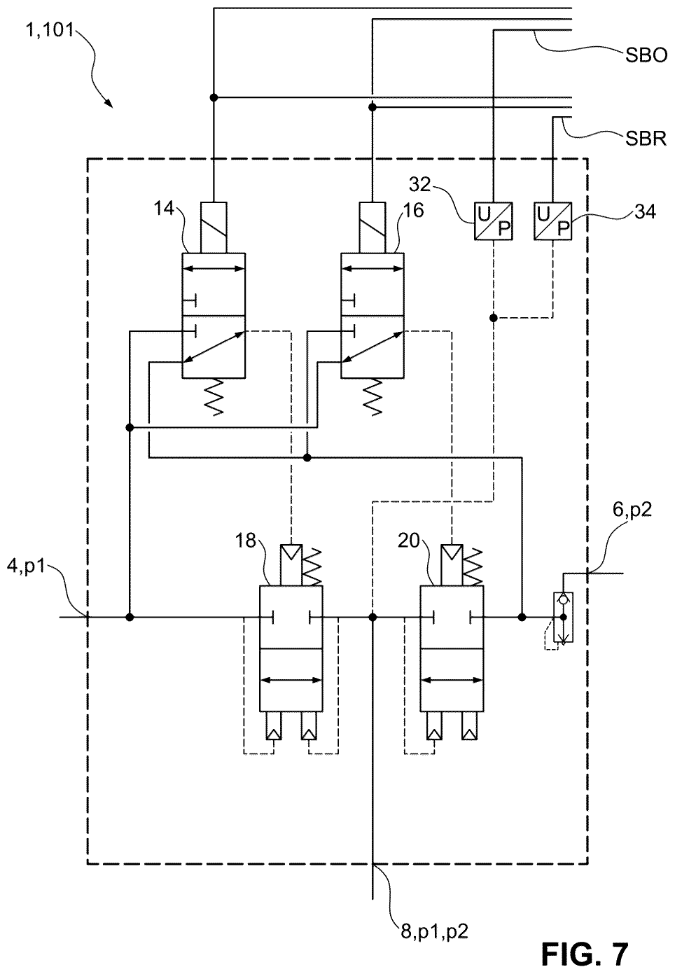

Lastly, FIG. 7 generally illustrates the provision of at least one pressure sensor 32, which detects the pressure modulated at the brake actuator connection 8. The pressure sensor 32 provides a brake pressure signal SBD, preferably to at least one service control unit 110. The pressure sensor 32 can also be connected to the redundancy control unit 140 via Y cabling, for example, and can also provide the brake pressure signal SBD to this. In the embodiment shown in FIG. 7, however, a redundant pressure sensor 34 is provided instead, which also detects the pressure modulated at the brake actuator connection 8 and provides a redundant pressure signal SBR. The redundant brake pressure signal SBR is preferably provided at least at the redundancy control unit 140, but can additionally or alternatively also be provided at the service control unit 110. This creates comprehensive redundancy.

It is understood that the foregoing description is that of the preferred embodiments of the invention and that various changes and modifications may be made thereto without departing from the spirit and scope of the invention as defined in the appended claims.

### LIST OF REFERENCE SIGNS (Part of the Description)

1 redundancy valve assembly
1b-1f second to sixth redundancy valve assembly
2 redundancy valve module housing
4 service brake pressure connection
6 redundancy brake pressure connection
8 brake actuator connection
solenoid valve unit
12 main valve unit
14 service pilot valve
14.1 first service pilot valve connection
14.2 second service pilot valve connection
14.3 third service pilot valve connection
14.4 first electromagnet
14.5 third electromagnet
16 redundancy pilot valve
16.1 first redundancy pilot valve connection
16.2 second redundancy pilot valve connection
16.3 third redundancy pilot valve connection
16.4 second electromagnet
16.5 fourth electromagnet
18 service main valve
18.1 first service main valve connection
18.2 second service main valve connection
18.3 service control connection
18.4 first service feedback connection
18.5 second service feedback connection
18A blocking position of the service main valve
18B passage position of the service main valve
20 redundancy main valve
20.1 first redundancy main valve connection
20.2 second redundancy main valve connection
20.3 redundancy control connection
20.4 first redundancy feedback connection
20.5 second redundancy feedback connection
20A blocking position of the redundancy main valve
20B passage position of the redundancy main valve
22 rapid bleed valve
22.1 first rapid bleed valve connection
22.2 second rapid bleed valve connection
22.3 third rapid bleed valve connection
24 inlet pilot valve
24.1 first inlet pilot valve connection
24.2 second inlet pilot valve connection
24.3 third inlet pilot valve connection
26 outlet pilot valve
26.1 first outlet pilot valve connection
26.2 second outlet pilot valve connection
26.3 third outlet pilot valve connection
27 separate venting path
28 first shuttle valve
30 second shuttle valve
32 pressure sensor
34 redundant pressure sensor
40 service brake pressure path
42 venting path
100 ABS valve
101 redundancy valve unit configured as ABS valve
102 brake modulator connection
104 ABS pilot control unit
106 ABS main valve unit
110 service control unit
112 first service axle modulator
113 front axle modulator
114 second service axle modulator
115 rear axle modulator
116 central module
120 first supply connection
122a first service brake pressure output
122b second service brake pressure output
124 ABS inlet valve
126 ABS outlet valve
128 ABS inlet pilot valve
130 ABS outlet pilot valve
140 redundancy control unit
141 redundancy module
142 redundancy axle modulator
144 second redundancy axle modulator
146a first redundancy brake pressure output
146b second redundancy brake pressure output
200 vehicle
202 utility vehicle
204 electronically controllable pneumatic brake system
207 first service brake actuator
208a 208f first to sixth service brake actuator
209 first wheel speed sensor
209b 209f second to sixth wheel speed sensor
220 rear axle brake circuit
222 front axle brake circuit
224 first service compressed air supply
225 further first service compressed air supply
226 second service compressed air supply
227 further second service compressed air supply
228 vehicle BUS
230 autonomous driving unit
232 first supply line
234 first voltage source
236 second supply line
238 second voltage source
240 redundancy BUS
A1 first axle
A2 second axle
B1 service level
B2 first redundancy level
HA1 first rear axle
HA2 second rear axle
p1 service brake pressure
p1ABS ABS modulated service brake pressure
p2 redundancy brake pressure
p3 second service brake pressure
p4 second redundancy brake pressure
p5 third service brake pressure
p6 third redundancy brake pressure
pS1 first control pressure
pS2 second control pressure
pS3 third control pressure
pS4 fourth control pressure
pV supply pressure
S1 first switching signal
S2 second switching signal
S3 third switching signal
S4 fourth switching signal
S3b third switching signal for second redundancy valve assembly
S4b fourth switching signal for second redundancy valve assembly
SA brake request signals
SB service braking signals
SB2 second service braking signals
SB3 third service braking signals
SBD brake pressure signal
SBR redundant brake pressure signal
SD first wheel speed signals
SD2 SD6 second to sixth wheel speed signals
SR redundancy braking signals
SR2 second redundancy braking signals
SR3 third redundancy braking signals
VA front axle

1. A redundancy valve assembly for redundantly supplying a redundant brake pressure into a service brake pressure path of an electronically controllable pneumatic brake system for a vehicle, the redundancy valve assembly comprising:
a service brake pressure connection configured to receive a service brake pressure from a service brake pressure modulator;
a redundancy brake pressure connection configured to receive a redundancy brake pressure from a redundancy brake pressure modulator;
a brake actuator connection for connecting at least one brake actuator; and,
wherein the redundancy valve assembly is electrically actuatable in order to optionally modulate the service brake pressure or the redundancy brake pressure at said brake actuator connection.

2. The redundancy valve assembly of claim 1 further comprising:
a solenoid valve unit connected at least to said service brake pressure connection and said redundancy brake pressure connection; and,
said solenoid valve unit being switchable by at least one first switching signal, wherein the service brake pressure or the redundancy brake pressure at the brake actuator connection is modulated in dependence upon said at least one first switching signal.

3. The redundancy valve assembly of claim 2, wherein said solenoid valve unit includes an electromagnetic service pilot valve and an electromagnetic redundancy pilot valve; said electromagnetic service pilot valve is switchable by said at least one first switching signal and is configured to provide a first pilot pressure; and, said electromagnetic redundancy pilot valve is switchable by a second switching signal and is configured to provide a second pilot pressure.

4. The redundancy valve assembly of claim 1 further comprising a main valve unit connected to said service brake pressure connection, said redundancy brake pressure connection, and said brake actuator connection for optionally shutting off the service brake pressure or the redundancy brake pressure.

5. The redundancy valve assembly of claim 4, wherein said main valve unit includes a service main valve having a first service main valve connection connected to said service brake pressure connection and a second service main valve connection connected to said brake actuator connection; and, said service main valve separates said first service main valve connection and said second service main valve connection in a blocking position and connects said first service main valve connection and said second service main valve connection by pressurized fluid in a passage position.

6. The redundancy valve assembly of claim 3 further comprising
a main valve unit connected to said service brake pressure connection, said redundancy brake pressure connection, and said brake actuator connection for optionally shutting off the service brake pressure or the redundancy brake pressure;
said main valve unit including a redundancy main valve having a first redundancy main valve connection connected to said redundancy brake pressure connection and a second redundancy main valve connection connected to the brake actuator connection; and,
wherein said redundancy main valve separates said first redundancy main valve connection and said second redundancy main valve connection in a blocking position and connects said first redundancy main valve connection and said second redundancy main valve connection by pressurized fluid in a passage position.

7. The redundancy valve assembly of claim 5 further comprising:
a solenoid valve unit connected at least to said service brake pressure connection and said redundancy brake pressure connection;
said solenoid valve unit being switchable by at least one first switching signal, wherein the service brake pressure or the redundancy brake pressure at the brake actuator connection is modulated in dependence upon said at least one first switching signal;
said solenoid valve unit including an electromagnetic service pilot valve and an electromagnetic redundancy pilot valve;
said electromagnetic service pilot valve being switchable by said at least one first switching signal and is configured to provide a first pilot pressure;
said electromagnetic redundancy pilot valve being switchable by a second switching signal and is configured to provide a second pilot pressure;
said service main valve being pneumatically switchable and has a service control connection connected to said solenoid valve unit for receiving the first pilot pressure; and,
said service main valve being spring biased into said blocking position.

8. The redundancy valve assembly of claim 6, wherein said redundancy main valve is pneumatically switchable and has a redundancy control connection connected to said solenoid valve unit for receiving the second pilot pressure; and, said redundancy main valve is spring biased into said blocking position.

9. The redundancy valve assembly of claim 3, wherein the first switching signal and the second switching signal are provided by a redundancy control unit.

10. The redundancy valve assembly of claim 1, wherein an ABS valve is connected upstream of said service brake pressure connection so that an ABS modulated service brake pressure is provided to said service brake pressure connection.

11. The redundancy valve assembly of claim 1, wherein the redundancy valve assembly is configured as an ABS valve and is configured to modulate the service brake pressure received at said service brake pressure connection in an ABS modulated manner at said brake actuator connection.

12. The redundancy valve assembly of claim 1 further comprising a rapid bleed valve for venting the pressure modulated at said brake actuator connection.

13. The redundancy valve assembly of claim 12, wherein said rapid bleed valve is connected to said redundancy brake pressure connection such that the redundancy brake pressure is optionally modulatable via the rapid bleed valve and the brake actuator connection is ventable.

14. The redundancy valve assembly of claim 13, wherein said rapid bleed valve has a first rapid bleed valve connection connected to said redundancy brake pressure connection, a second rapid bleed valve connection connected to said main valve unit, and a third rapid bleed valve connection connected to a venting arrangement.

15. The redundancy valve assembly of claim 9, wherein said electromagnetic service pilot valve is switchable by a third switching signal and said electromagnetic redundancy pilot valve is switchable by a fourth switching signal; and, a service control unit is configured to provide the third switching signal and the fourth switching signal.

16. The redundancy valve assembly of claim 3, wherein said solenoid valve unit includes an electromagnetic inlet pilot valve and an electromagnetic outlet pilot valve; said electromagnetic inlet pilot valve is switchable by an inlet switching signal and is configured to provide a third pilot pressure; and, said electromagnetic outlet pilot valve is switchable by an outlet switching signal and is configured to provide a fourth pilot pressure.

17. The redundancy valve assembly of claim 16, wherein the inlet switching signal and the outlet switching signal are provided by a service control unit.

18. The redundancy valve assembly of claim 15 further comprising
a main valve unit connected to said service brake pressure connection, said redundancy brake pressure connection, and said brake actuator connection for optionally shutting off the service brake pressure or the redundancy brake pressure;
said main valve unit having a first shuttle valve configured to modulate the first pilot pressure and a third pilot pressure; and,
said main valve unit having a second shuttle valve configured to modulate the second pilot pressure and a fourth pilot pressure.

19. The redundancy valve assembly of claim 1 further comprising a pressure sensor configured to detect a pressure modulated at said brake actuator connection.

20. An electronically controllable pneumatic brake system for a vehicle, comprising:
a service control unit for controlling the electronically controllable pneumatic brake system in an operating mode;
at least one service axle modulator connected to said service control unit and configured to receive service braking signals from said service control unit and to modulate a service brake pressure for a first axle on a basis of said service braking signals;
a redundancy control unit for controlling the electronically controllable pneumatic brake system in a redundancy mode;
at least one redundancy axle modulator connected to said redundancy control unit and configured to receive redundancy braking signals from said redundancy control unit and to modulate a redundancy braking pressure for the first axle on a basis of said redundancy brake signals;
at least one redundancy valve assembly for redundantly supplying the redundant brake pressure into a service brake pressure path of the electronically controllable pneumatic brake system for a vehicle;
said at least one redundancy valve assembly including a service brake pressure connection, a redundancy pressure brake connection, and a brake actuator connection for connecting at least one brake actuator;
said service brake pressure connection being configured to receive a service brake pressure from said at least one service brake pressure modulator;
said redundancy brake pressure connection being configured to receive a redundancy brake pressure from a redundancy brake pressure modulator;
said at least one redundancy valve assembly being electrically actuatable in order to optionally modulate the service brake pressure or the redundancy brake pressure at said brake actuator connection;
said service brake pressure connection being connected to said at least one service axle modulator and configured to receive the service brake pressure from said service axle modulator;
said redundancy brake pressure connection being connected to said redundancy axle modulator and being configured to receive the redundancy brake pressure from said redundancy axle modulator; and,
said brake actuator connection being connected to at least one first service brake actuator on the first axle.

21. The electronically controllable pneumatic brake system of claim 20, wherein said at least one redundancy valve assembly is connected to said redundancy control unit and is configured to receive a first switching signal and a second switching signal from said redundancy control unit.

22. The electronically controllable pneumatic brake system of claim 20, wherein said at least one redundancy valve assembly is connected to said service control unit and configured to receive from said service control unit at least one of i) a third switching signal and a fourth switching signal and ii) an inlet switching signal and an outlet switching signal

23. The electronically controllable pneumatic brake system of claim 20 further comprising:
a first wheel speed sensor at the first axle; and,
said first wheel speed sensor being connected to both said service control unit and said redundancy control unit and configured to provide a first wheel speed signal at said service control unit and said redundancy control unit.

24. The electronically controllable pneumatic brake system of claim 21 further comprising:
a first wheel speed sensor at the first axle;
said first wheel speed sensor being connected to both said service control unit and said redundancy control unit and configured to provide a first wheel speed signal at said service control unit and said redundancy control unit; and,
wherein said first switching signal and said second switching signal are generated and provided by said redundancy control unit based on the first wheel speed signal.

25. The electronically controllable pneumatic brake system of claim 20, wherein said redundancy valve assembly is arranged on said first service brake actuator or installed adjacent to said first service brake actuator.

26. The electronically controllable pneumatic brake system of claim 20, wherein at least one of said at least one redundancy valve assembly is provided on each axle of the vehicle.

27. The electronically controllable pneumatic brake system of claim 20, wherein at least one of said at least one redundancy valve assembly is provided on each service brake actuator.

28. The electronically controllable pneumatic brake system of claim 20 further comprising a second redundancy valve assembly having a service brake pressure connection connected to said service axle modulator and configured to receive said service brake pressure from said service axle modulator; said second redundancy valve assembly having a redundancy brake pressure connection connected to said redundancy axle modulator and configured to receive the redundancy brake pressure from said redundancy axle modulator; and, a third redundancy valve assembly having a brake actuator connection connected to at least one second service brake actuator on the first axle.

29. The electronically controllable pneumatic brake system of claim 20, wherein the vehicle is a utility vehicle.

30. The electronically controllable pneumatic brake system of claim 28 further comprising:
at least one second service axle modulator connected to said service control unit and configured to receive service braking signals from said service control unit and to modulate a second service brake pressure for a second axle based on said service brake signals;
at least one second redundancy axle modulator connected to said redundancy control unit and configured to receive redundancy braking signals from said redundancy control unit and to modulate a second redundancy braking pressure for the second axle based on said redundancy braking signals; and
a third redundancy valve assembly;
said third redundancy valve assembly having a service brake pressure connection connected to said second service axle modulator and configured to receive the second service brake pressure from said second service axle modulator;
said third redundancy valve assembly having a redundancy brake pressure connection connected to said second redundancy axle modulator and configured to receive the second redundancy brake pressure from said second redundancy axle modulator; and,
said third redundancy valve assembly having a brake actuator connection connected to at least one third service brake actuator on the second axle.

31. A vehicle comprising:
at least a first axle;
a second axle;
the electronically controllable pneumatic brake system of claim 20.

32. The vehicle of claim 31, wherein the vehicle is a utility vehicle.

33. A method for controlling an electronically controllable pneumatic brake system, the method comprising:
in an operating mode of the electronically controllable pneumatic brake system, modulating a service brake pressure by a service brake pressure modulator at a service brake pressure connection of a redundancy valve assembly,
actuating the redundancy valve assembly by a service control unit based on first wheel speed signals and thereby providing slip controlled modulation of the service brake pressure at a brake actuator connection of the redundancy valve assembly; and,
in a redundancy mode of the electronically controllable pneumatic brake system,
modulating a redundancy brake pressure by a redundancy axle modulator at a redundancy brake pressure connection of the redundancy valve assembly; and,
actuating the redundancy valve assembly by a redundancy control unit based on the first wheel speed signals and thereby providing slip controlled modulation of the redundancy brake pressure at the brake actuator connection.

34. The method of claim 33, wherein the electronically controllable pneumatic brake system includes a service control unit for controlling the electronically controllable pneumatic brake system in an operating mode; the electronically controllable pneumatic brake system further includes at least one service axle modulator connected to the service control unit and configured to receive service braking signals from the service control unit and to modulate a service brake pressure for a first axle on a basis of the service braking signals; the electronically controllable pneumatic brake system further having a redundancy control unit for controlling the electronically controllable pneumatic brake system in a redundancy mode and at least one redundancy axle modulator connected to the redundancy control unit and configured to receive redundancy braking signals from the redundancy control unit and to modulate a redundancy braking pressure for the first axle on a basis of the redundancy brake signals; the electronically controllable pneumatic brake system having at least one redundancy valve assembly for redundantly supplying the redundant brake pressure into a service brake pressure path of the electronically controllable pneumatic brake system for a vehicle; the at least one redundancy valve assembly including a service brake pressure connection, a redundancy pressure brake connection, and a brake actuator connection for connecting at least one brake actuator; the service brake pressure connection being configured to receive a service brake pressure from the at least one service brake pressure modulator; the redundancy brake pressure connection being configured to receive a redundancy brake pressure from a redundancy brake pressure modulator; the at least one redundancy valve assembly being electrically actuatable in order to optionally modulate the service brake pressure or the redundancy brake pressure at said brake actuator connection; the service brake pressure connection being connected to the at least one service axle modulator and configured to receive the service brake pressure from the service axle modulator; the redundancy brake pressure connection being connected to said redundancy axle modulator and being configured to receive the redundancy brake pressure from the redundancy axle modulator; and, the brake actuator connection being connected to at least one first service brake actuator on the first axle.
